(19) United States
(12) Patent Application Publication
(10) Pub. No.: US 2008/0114619 A1
(43) Pub. Date: May 15, 2008

(54) Method of Reinsuring an Insolvent Insurance or Reinsurance Company's Liabilities

(76) Inventors: Forrest Krutter, Omaha, NE (US); William O'Farrell, Darien, CT (US)

Correspondence Address: BRINKS HOFER GILSON & LIONE, P.O. BOX 10395, CHICAGO, IL, 60610, UNITED STATES, 312-321-4200, 312-321-4299, OFFICEACTIONS@BRINKSHOFER.COM

(21) Appl. No.: 09/524,189

(22) Filed: Mar. 13, 2000

(51) Int. Cl. G06Q 40/00

(52) U.S. Cl. 705/4; 705/35

(57) ABSTRACT

The invention provides a method for reinsuring an insolvent Insurance Company's liabilities. The method includes determining the shortfall of the Insurance Company's assets and Reinsurer's obligations to cover underlying claims, determining a guaranteed payment rate of the claims, and indemnifying at least a portion of the Insurance Company's liability for the claims at the guaranteed rate, in exchange for rights to at least a portion of the assets, including the Reinsurers obligations.

### BACKGROUND OF THE INVENTION

This invention relates to a risk transfer product for the reinsurance industry. In particular, this invention relates to a method for reinsuring the liabilities of an insolvent Insurance or Reinsurance Company (hereafter “Insurance Company”).

It is well known by most people that insurance is a promise to pay. An insured individual pays an amount of money, known as premium, to an insurance company in exchange for the promise of the Insurance Company to pay should the insured suffer a loss covered by the insurance policy. Thus, the risk of a loss is transferred to the insurance company in exchange for the payment of a premium. However, if the Insurance Company becomes insolvent (i.e., its liabilities exceed its assets), the promise is broken. The Insurance Company cannot pay the full amount of the insured's loss, and accordingly, a portion of the loss falls back to the insured.

When an Insurance Company becomes insolvent, the Insurance Company often goes into liquidation. The administration of the estate of the Insurance Company is overseen by a State Liquidation Court, which is analogous to a Bankruptcy Court. A Liquidator is then appointed to marshal the Insurance Company's assets and adjust all claims in accordance with state statutory guidelines. In most states the insurance regulatory official (e.g., the state insurance commissioner) is appointed to serve as liquidator.

An Insurance Company liquidation typically remains open until all of the claims against the Insurance Company are known and adjudicated, and the assets accounted for and distributed. However, the value of some claims, often referred to as latent injury claims, or long-tail claims, are not known until they manifest years later. Asbestos and pollution claims are examples of claims where the damages are not known until they manifest years after they were actually incurred.

In a typical liquidation, claimants submit proofs of claim (POC) to the Liquidator who determines coverage, values the claims, and responds to the claimants with a notice of determination (NOD) that either allows or disallows the claim and establishes the priority of the claim. Traditionally, NODs for stated dollar amounts represent claims that have been proved up by evidence of payment by the insured or claimant. A typical example would be an automobile claim where the insured is required to pay a set amount for injury he caused in an accident for which the insured was at fault. However, where there are latent injury claims, NODs for unstated amounts are often issued by the liquidator, as no set amount can be determined at the time following the liquidation. These NOD's generally represent claims for unliquidated or contingent claims. In addition, insureds will have “incurred but not reported” (IBNR) losses. IBNR losses are based on mathematical techniques that indicate losses probably occurred, but which insured suffered these losses and the amount of each such insured's losses cannot be determined, as the claims have not yet been made against an insured by a claimant. IBNR reserves are often established by solvent insurance companies for claims such as the latent injury claims described above. Because IBNR losses can take decades to emerge, the liquidation remains open until such claims mature. This time period is known as the run-off period.

During liquidation, it is typically the case that the payouts to claimants are held back in whole or in part until the ultimate liability for all pending claims is known. To ensure all creditors of the same priority receive the same distribution, the Liquidator does not pay or pays only a fraction of the amount of each claim as an interim distribution until the value of all claims is known. To avoid unequal distribution of remaining assets to all claimants, the Liquidator often asks the claimants to execute refunding agreements with respect to all interim distributions. These refunding agreements allow the Liquidator to require the insured to repay to the liquidator interim payments, in whole or in part, should the liabilities turn out to be greater than expected. This is the only method currently available to the Liquidator to avoid overpaying early claims leaving insureds submitting claims later (especially payments by insureds to settle latent injuries) no recovery. This result is inevitable given the substantial uncertainty inherent in estimating losses that may be reported by insureds for decades to come.

Other methods have been put forth to improve liquidation administration to accelerate the closing of the liquidation, such as paying the present value of an estimate of the long-tail claim losses or setting cutoff dates on unemerged losses. These methods for handling the liquidation lack a risk transfer mechanism and, in some instances, have resulted in substantial litigation. They also deprive certain insureds of the percentage of the claim to which they are entitled and unfairly benefit early claimants contrary to the intent of the state insurance liquidation statutes, which require that all insureds of the same priority be treated equally.

Empirical data for insurance liquidations shows that it may take 25 or more years to adjust all claims and distribute the assets involved in an insurance company liquidation. Thus, an insured is usually reimbursed only a portion of their loss, if any, years after suffering the loss.

Therefore, there is a need for new methods for transferring certain risks inherent in administering estates of insolvent Insurance Companies and the methods of the present invention would provide a substantial benefit to such policyholders.

### SUMMARY OF THE INVENTION

A method for reinsuring an insolvent Insurance Company's liabilities is provided. In one aspect, the method includes estimating values of the Insurance Company's assets and liabilities, guaranteeing the payment of a percentage of an allowed claim to insureds as a function of said values in the form of a dividend from the insolvent Insurance Company (preferably without the right of the insolvent Insurance Company to demand repayment), and obtaining rights to at least a portion of the assets of the insolvent Insurance Company. In another aspect, the method includes determining the shortfall of the Insurance Company's assets including Reinsurer's obligations to cover underlying claims, determining a guaranteed payment rate of the claims, indemnifying at least a portion of the Insurance Company's liability for the claims at the guaranteed payment rate, and assigning at least a portion of the insolvent Insurance Company's assets, including the Reinsurer's obligations, to an Indemnifying Agent.

These methods have the following advantages: they guarantee claimants a prompt dollar certain payment on allowed claims that may substantially exceed, on a present value basis, the amount received under the currently used system of insurance company liquidation; and they transfer the risk and uncertainty regarding the amount of future loss development and uncorrectable assets to the Indemnifying Agent. The methods also potentially reduce litigation over liquidation orders in a way that would be endorsed both by claimants and Insurance Companies alike. The methods also permit the orderly collection of the assets of the insolvent Insurance Company (which often consists of reinsurance which is due to be paid solely at the time the amount of the loss is determined in an NOD). Finally, the methods shift the risks of any future inefficient and inadequate estate administration to a new Deputy Liquidator. These and other advantages will be apparent from the detailed description that follows.

### DETAILED DESCRIPTION OF THE PREFERRED EMBODIMENT OF THE INVENTION

This invention is applicable to insolvent Insurance Companies and insolvent Reinsurance Companies. Reinsurance companies “insure” the risks of other insurance companies. In this way the insurance company buying the reinsurance (generally known as a cedent) can limit its risks due to extreme losses on individual claims or due to catastrophes such as hurricanes. When the seller of the reinsurance (the assuming company) becomes insolvent, the promise made by the assuming company to the cedent is broken and the same issues arise as exist between insolvent reinsurer and the cedent. Thus, this invention applies to insolvent insurers, insolvent reinsurers and insolvent companies who sold both insurance and reinsurance. In applying the invention to an insolvent company who sold reinsurance, the term “Insured” includes cedents and the term “insurance Company” includes assuming companies.

In accordance with a first embodiment of the invention, a method is provided for reinsuring insolvent Insurance Company's liabilities. In brief, this method includes estimating the value of the Insurance Company's assets and liabilities, guaranteeing the payment of a guaranteed dividend to insureds of the insolvent Insurance Company (which is a percentage of the amount to which the Insured is determined to be entitled and would have received but for the insolvency of the Insurance Company), and to the party guaranteeing the payments (i.e., the Indemnifying Agent), obtaining rights to at least a portion of the assets of the insolvent Insurance Company, including the rights to the reinsurance associated with the liabilities. The Indemnifying Agent is typically a reinsurance company and the guarantee is effectuated through a reinsurance agreement. For the purposes of this application, this reinsurance agreement will be referred to as the Aggregate Reinsurance Agreement.

In a second embodiment, a method is provided that includes estimating the value of the Insurance Company's portfolio of assets, estimating the value of claims against the Insurance Company, evaluating obligations of reinsurers against those claims, determining the shortfall of the assets, including reinsurers' obligations to cover the claims, and the administrative costs associated with the claims, determining a guaranteed payment rate of said claims as a function of the shortfall, indemnifying at least a portion of the Insurance Company's liabilities for the claims at the guaranteed payment rate, and assigning at least a portion of the assets, including the reinsurers' obligations, to the Indemnifying Agent.

Preferably, the claims are assigned a particular priority, and a guaranteed payment rate is determined for claims of each different priority. Each state's laws sets forth different classes of persons and the order of their entitlement to the assets of the insolvent Insurance Company. For example, employees entitled to certain wage payments may be entitled to receive payment in full before any insured is paid. Accordingly, this method may follow the local laws in assigning priorities to claimants or insureds.

In addition, this method may optionally include assigning an upper limit on the aggregate amount for which the Indemnifying Agent is liable. The method also optionally includes assigning to the Indemnifying Agent all rights that the Insurance Company may have for any salvage or subrogation to which the Insurance Company is entitled. Also, the method may optionally include assigning to the Indemnifying Agent a security interest in at least some of the Insurance Company's assets and other security due to or held in the Insurance Company's favor. Preferably, the method includes appointing a Liquidator or Deputy Liquidator (which may be the Indemnifying Agent or an affiliate or subcontractor) to administer the insolvent Insurance Company.

In a third embodiment of the invention, a method is provided that is carried out with the use of a computer. This method includes generating one or more statistical models representative of known cost values based on significant characteristics of historical insurance claims representative of immature insurance claims against the Insurance Company and storing the statistical models in a first memory storage area on a computer. The memory storage area may be a diskette, a hard drive, RAM, or the like. Significant characteristics of the insurance claims for unstated amounts are determined and the statistical models are applied to the insurance claims for unstated amounts to estimate the actual losses anticipated for those claims. The expected amount due from reinsurers of the insolvent Insurance Company for claims for unstated amounts are then estimated, and the present value of the reinsurers' obligations are calculated. A guaranteed payment rate against those claims are calculated based on the present value of Insurance Company assets, including the present value of its reinsurers obligations, and the present value of all claims against the insurance company. The guaranteed payment rate is stored in a second memory storage area. The second memory storage area may be on the same computer as the first storage area, or on a different computer. An Indemnifying Agent indemnifies the insolvent Insurance Company against the claims at the guaranteed payment rate in exchange for the rights to the Insurance Company's assets, including the insolvent Insurance Company's reinsurers' obligations.

The separate estimations, calculations, or determinations of the values of the assets and liabilities of an Insurance Company may be performed using traditional methods and models known to those skilled in the art of actuarial estimation. But, the value of an Insurance Company's total assets is not easily determined. The insolvent Insurance Company's largest asset is typically its reinsurers' obligations, also referred to as reinsurance recoverables. The amount collectible from reinsurance is often subject to such factors as future loss size and frequency, underwriting year and program distribution of losses and the credit quality of the reinsurer over twenty or more years of the run-off of the liquidation.

Estimating the liabilities of insolvent Insurance Companies is also difficult. While NODs for stated amounts are readily quantifiable, NODs for unstated amounts require use of actuarial and statistical techniques to estimate their value. Long-tail claims for occurrences such as product liability, medical malpractice, asbestos and environmental exposure, often take years to mature into actual quantifiable losses to the insureds and are subject to high variability of result.

In estimating the value of these long-tail claims, statistical models that look at the historical frequency and severity of similar types of claims may be useful. The models can be used to predict the potential losses that would be incurred on future claims having similar significant characteristics. For example, U.S. Pat. No. 5,613,072 issued to Hammond et al. on Mar. 18, 1997, entitled System for Funding Future Worker's Compensation Losses, which is incorporated by reference herein, discloses methods for generating statistical models that may accurately predict future losses to be incurred on certain types of insurance claims.

The insolvent Insurance Company may have varying levers of reinsurance by underwriting year issued by numerous reinsurers located worldwide. After estimating the value of the claims against the insolvent Insurance Company, it is possible to then estimate how much of those claims may be recovered from the insolvent Insurance Company's reinsurers. Although, the insolvent Insurance Company will pay the claimant none or a fraction of the actual loss submitted on the claims, under most state laws, the amount recoverable from a reinsurer is not reduced or diminished as a result of the insolvency of the Insurance Company notwithstanding any provision in the reinsurance contract or other such agreement. But, one complicating factor for estimating the recovery from reinsurers is, of course, that the financial stability of the reinsurers must be evaluated long into the future and for varying level of losses. Since the long-tail claims may take decades for actual losses to be known, the total estimated value of the reinsurers' obligations against those claims must be discounted by a credit risk factor, due to the risk that the reinsurers may themselves become insolvent by the time the claims mature. In addition, interpretations of reinsurance contracts have evolved over the years, and there is a risk that currently accepted interpretations of reinsurance contracts will change over time.

After evaluating the expected recovery from the reinsurers against the claims, the Indemnifying Agent estimates the administrative costs associated with administering the estate of the insolvent Insurance Company during the runoff period. The administrative costs may be paid out of the assets of the insolvent Insurance Company, or by the Indemnifying Agent under the Aggregate Reinsurance Agreement. Those administrative costs cover the expenses for handling the duty of the Liquidator and/or Deputy Liquidator as described below and generally are Priority 1 claims, paid at a 100% basis.

The shortfall of the estate to cover its liabilities can be approximated by deducting the present value of the estimated claim losses and the administrative costs associated with those claims from the total value of the assets, including the present value of the reinsurers' obligations for claims on a risk-adjusted basis. Based on that shortfall, it is possible to apply a range of risk factor premiums to determine a guaranteed payment rate of the claims against the Insurance Company. By guaranteeing the payment of claims against the Insurance Company at a certain dividend rate, or fraction of the stated amount, the risks associated with variances in claim estimations, asset valuations and failed reinsurance are transferred from the Estate (i.e., ultimately the insureds) to the Indemnifying Agent. The Indemnifying Agent is the party, or parties, guaranteeing, or indemnifying, the insolvent Insurance Company for the payment of the claims at a certain percentage of the Insured's loss as determined in a NOD.

In exchange for that indemnification, or guarantee, at least a portion of the assets of the Insurance Company are transferred to the Indemnifying Agent. These transferred assets include the rights to recover from the reinsurers' on the claims, and preferably, the cash and cash equivalents of the insolvent Insurance Company. In addition, any salvage and subrogation rights to which the Insurance Company is entitled may be transferred to the Indemnifying Agent. Further, the Indemnifying Agent may obtain a security interest in at least some of the Insurance Company's rights in any secured deposits or other funds held by any estate, trusts, letters of credit, or other securities due or held in the Insurance Company's favor.

The guaranteed payment rate, also referred to herein as guaranteed dividend rate, is that fraction of the allowed claim that the Indemnifying Agent would reimburse to the insolvent Insurance Company for payment to the claimants. Optionally, there may be more than one priority of allowed claims, and therefore, different guaranteed payment rates.

In one embodiment, the guaranteed payment rate for Allowed Claims may be determined by estimating the present value of the Insurance Company's assets plus the present value of the recovery from the reinsurers accounting for the credit and other risks of the reinsurers. This total is divided by the present value of the allowed claims against the Insurance Company and the estimated present value of immature claims against the insolvent Insurance Company. The calculations may also allow for estimated inflation rates, risk premiums, and return on investment required by the Indemnifying Agent.

Other costs or benefits may be factored into the guaranteed payment rate calculation. In cases where the Indemnifying Agent or an affiliate may also be responsible for the administrative costs for overseeing the estate of the insolvent Insurance Company, those administrative costs may also be considered in that calculation. Moreover, any other assets such as rights in secured deposits or other funds held in the Insurance Company's favor may be included in that calculation with a discount for the potential of realizing those assets. To the extent there may be some valuable salvage rights available to the Insurance Company and those rights are assigned to the Indemnifying Agent, those values may also be incorporated into calculating the guaranteed payment rate.

To carry out the method of this invention, it is preferred that an affiliate of the Indemnifying Agent, or the Indemnifying Agent itself, be appointed as the Liquidator or a Deputy Liquidator to administer the estate of the insolvent Insurance Company. In practice, the Liquidator or Deputy Liquidator evaluates claims and recovers the amount of dividends due on Allowed Claims from the Indemnifying Agent, subject to the terms and conditions of the “Aggregate Reinsurance Agreement” that sets forth the Indemnifying Agents obligations to payout at a guaranteed dividend rate. The Indemnifying Agent may receive all or a part of the Insurance Company's rights against any reinsurer that may be liable for all or any part of any claims during the term of the Aggregate Reinsurance Agreement and thereafter with respect to all underlying claims for which Indemnifying Agent indemnifies the Insurance Company. The Liquidator or Deputy Liquidator administers the estate of the Insurance Company with the following rights and obligations that may include, but are not limited to, the following:

Claims Administration: Contracting for or hiring as necessary qualified personnel to investigate, evaluate, settle or compromise all claims, subject to the determination of the Liquidation Court on all Notices of Determination with respect to the claims. In the event of legal, administrative, or other proceedings by or against the Insurance Company, the Liquidator or Deputy Liquidator selects, hires and supervises counsel to represent the Insurance Company therein, provided that payment of any obligations of the Insurance Company for administrative expenses may be subject to the approval of the Liquidation Court to the extent required.

Commutations: Commuting or otherwise reforming: (a) The Insurance Company's liabilities arising under any Insurance Policy or an Insurance Company Assumed Reinsurance Contract; (b) any reinsurance or retrocession of the Insurance Company (other than the Aggregate Reinsurance Agreement); or (c) any obligations of any person to the Insurance Company, subject to the approval of the Liquidation Court to the extent required by state law.

Reinsurance Recoverables: Collecting reinsurance from the Insurance Company's reinsurers under all reinsurance and retrocessions that are ceded by the Insurance Company, regardless of the priority of the Claim. In carrying out these duties, the Liquidator may grant to the Deputy Liquidator all rights that the Insurance Company has under such reinsurance and retrocessions to draw down letters of credit, trusts and funds withheld and to otherwise access security provided to the Insurance Company in order to collect reinsurance from the reinsurers. The Liquidator or Deputy Liquidator undertakes to perform all acts necessary to fulfill the Insurance Company's obligations to the reinsurers. The Deputy Liquidator submits accounts and claims to the reinsurers, through intermediaries or otherwise, and makes reasonable attempts to promptly collect amounts due the Insurance Company.

For as long as the Aggregate Reinsurance Agreement is in effect and possibly thereafter with respect to the underlying claims for which the Indemnifying Agent indemnifies the Insurance Company, the Indemnifying Agent is assigned all of the rights of the Insurance Company against any person or entity liable to the Insurance Company or an Insured in respect of the Ultimate Net Loss. The Indemnifying Agent is entitled to any salvage, subrogation, or reinsurance recoverables to which the Insurance Company would be entitled. The whole of any receipts is credited for the sole benefit of the Indemnifying Agent, net of external expenses of collection.

In addition, the Indemnifying Agent may be granted a first, prior perfected security interest in all of the Insurance Company's rights to all secured deposits or similar funds held by any state, and all funds held, trusts, letters of credit, or other security dues to or held in the Insurance Company's favor. The Liquidator or Deputy Liquidator cooperates with the Indemnifying Agent to exercise the Indemnifying Agents' rights under the Aggregate Reinsurance Agreement. The Liquidator or Deputy Liquidator promptly collects recoverables, including but not limited to, charging collections against funds held, withdrawing funds from trusts, or drawing down on letters of credit. The Liquidator or Deputy Liquidator may collect from solvent reinsurers and/or other parties amounts in excess of the Ultimate Net Loss indemnified by the Indemnifying Agent. Such recoveries are the property of the Indemnifying Agent, provided that the rights of the Insurance Company's other reinsurers to any salvage or subrogation they may be due are not diminished, and their obligation to make timely payments without diminution to the Insurance Company are not affected.

Systems: Contracting or hiring, as necessary, qualified personnel to maintain and operate computer, operational and other management systems as may be necessary for the proper administration of the estate of the Insurance Company and as needed to provide the reports to the Liquidator and to the Liquidation Court.

Legal and Regulatory: Contracting or hiring, as necessary, qualified personnel to handle legal or regulatory issues as may arise in connection with administering claims, provided that all payments such of administrative expenses should be subject to prior approval of the Liquidation Court.

Accounting: Contracting or hiring, as necessary, qualified personnel to maintain the accounting books and records pertaining to the claims and to prepare any and all necessary internal and external reports pertaining thereto.

In consideration for administrating the estate of the Insurance Company, the Liquidator or Deputy Liquidator is paid an annual fee preferably by the Insurance Company. This fee is preferably adjusted annually by the increase, if any, in inflation, such as measured by the Consumer Price Index (CPI) or other indices. Such expense is a Priority 1 expense for the Insurance Company, and is paid by the Insurance Company to the Liquidator or Deputy Liquidator. Priority 1 expenses are typically paid in full. This fee is in addition to expenses to be paid by the Insurance Company for auditing, legal and/or consulting services incurred for the benefit of the Liquidator or as required to comply with an order of the Liquidation Court. This fee should be adjusted in the event new regulatory and/or judicial requirements are imposed on the Deputy Liquidator. This fee does not include any obligations of the Insurance Company for: (i) other Priority 1 Expenses or other liabilities of the Insurance Company; (ii) any claim for loss under an Insurance Policy, the Insurance Company Assumed Reinsurance Contract or Contract of Reinsurance; or (iii) any Allocated Loss Adjustment Expenses.

### EXAMPLE

The following example is intended to illustrate a preferred embodiment of this invention, but should not be considered as limiting the invention.

In a liquidation of insolvent Insurance Company A, the liquidation estate has liquid assets of $380 million against actual allowed losses (as determined in NOD's) of $550 million and with future losses (Remaining Ultimate) expected to range from $1,000 to $3,000 million. Table 1 provides a brief overview of the insolvent Insurance Company's financial position. If the current actual allowed losses were paid out at 50 cents on the dollar (i.e., 50% of the $550 million in approved claims), only $245 million would remain in the estate to cover the future losses (expected to be from 1,000 to 3,000 million) and administrative fees, not accounting for future reinsurance recoveries. Historically, a dividend rate of 30 cents on the dollar has been paid by the Liquidator to preserve the estate's liquid assets for claims quantified in the future.

Some of the relevant factors applied to this analysis include a Net Present Value (NPV) factor of 65% of the future value, which assumes the same average maturity of losses under all scenarios. A reinsurance lag factor discounts the reinsurance recoveries for the time it takes to collect such sums from the reinsurers on claims first paid by the Indemnifying Agent. The Maximum Reinsurance Recovery (based on expected loss severity and frequency without regard to reinsurer credit quality) is the percent of the total losses ultimately quantified and determined to be due that is expected to be covered by reinsurance obligations.

TABLE 1

| Insolvent Insurance Company A | (Amounts in millions) |
|---|---|
| Cash and cash equivalents | 380 |
| Actual Allowed Losses | 550 |
| Expected Range of Remaining Ultimate | 1,000 to 3,000 |
| Past Interim Distributions | 140 |
| Distribution Required to Bring Allowed Claims to | 135 |
| 50% Guaranteed Dividend Rate | |
| Post Distribution Cash | 245 |
| Provision for administrative costs | 40 |
| Reinsurance Lag Factor | 3% |
| NPV Factor | 65.0% |
| Guaranty Association Administrative Costs | 2.0% |
| Maximum Reinsurance Recovery on Allowed | 40% |
| Losses | |
| Limit of Aggregate Reinsurance Agreement | 3,000 |

As shown below in Table 2, the projected losses and credit risk of reinsurers are set forth on a statistical basis for five scenarios that are derived from actuarial models of the claims for a typical insolvent Insurance Company. The statistical average of those scenarios represents an expected Remaining Ultimate of $1,600 million, the NPV of which is approximately 65% of $1,600 million or $1,040 million. The NPV reinsurance recovery corresponding to the statistical average of the loss scenarios is $371 million on a risk-adjusted basis. Therefore, the total estimated assets are the post distribution cash of $245 million and the expected NPV reinsurance recovery (after deducting the 3% lag factor) of $359.87 million, for total assets of $604.87 million. A portion of the total assets is set aside to cover administrative costs ($40 million) and related Guaranty Association (GA) expenses (2% of NPV of Expected Remaining Ultimate or $20.8 million) on a 100% dividend rate, since these are typically Priority 1 claims that must be paid in full. Thus, the total assets available for covering insured policyholder claims, such as the long-tail claims, are $544.07 million. With the NPV of future losses expected to be $1040 million (and may in fact be significantly higher), a shortfall of about $495.93 million is estimated for the estate of insolvent Insurance Company A.

Based on these scenarios, the Indemnifying Agent may guarantee the dividend rate at 50 cents on the dollar (or 50%), which is a significant increase from the present 30 cents on the dollar (or 30%) dividend. The Indemnifying Agent receives the assets, including the post distribution cash of $245 million and the reinsurance recoveries, in exchange for accepting the risk of non-recovery from reinsurers, risk of incorrect estimation of the ultimate values of the long-tail claims and administrative costs, and risk of the time value of money.

TABLE 2
Statistical Analysis of Remaining Ultimate Loss (in millions)

| | | | Reinsurer | |
|---|---|---|---|---|
| | | | Credit | |
| | | | Risk | NPV |
| | Ultimate | Probability | Factor | Factor |
| Remaining Ultimate | 1,000 | 35% | 91% | 65% |
| scenario 1 | | | | |
| Remaining Ultimate | 1,500 | 30% | 91% | 65% |
| scenario 2 | | | | |
| Remaining Ultimate | 2,000 | 20% | 89% | 65% |
| scenario 3 | | | | |
| Remaining Ultimate | 2,500 | 10% | 87% | 65% |
| scenario 4 | | | | |
| Remaining Ultimate | 3,000 | 5% | 84% | 65% |
| scenario 5 | | | | |
| Expected Remaining | 1,600 | 100% | | |
| Ultimate | | | | |
| NPV of Expected | 1040 | | | |
| Remaining Ultimate | | | | |
| NPV of Expected | | | 371 | |
| Reinsurance Recoveries | | | | |

Current Dividend Rate=30 cents,
Proposed Guaranteed Dividend Rate=50 cents.

Another way of viewing this scenario is that the Liquidator agrees, on behalf of the claimants, to pay the Indemnifying Agent the assets on hand as a premium in exchange for a guarantee to make up the difference between a guaranteed dividend rate of 50% and the current dividend rate of 30%, and typically, to administer the insolvent Insurance Company. The Liquidator thus transfers the risk of lower reinsurance recoveries, higher Remaining Ultimate Losses and higher administrative costs to the Indemnifying Agent. In addition to no longer having to shoulder the risks transferred to the Indemnifying Agent, the claimants receive final payments as soon as their claims mature, rather than waiting until all other claims mature, and the runoff period ends, or being required to enter into recapture agreements in the event of a future shortfall.

The described embodiments are to be considered in all respects only as illustrative and not restrictive, and the scope of the invention is, therefore, indicated by the appended claims rather than by the foregoing description. All changes which come within the meaning and range of equivalency of the claims are to be embraced within their scope.

1. A method of paying an insolvent Insurance Company's liabilities through a reinsurance agreement or other indemnification arrangements, comprising:
a) estimating values of an Insurance Company's assets and liabilities;
b) guaranteeing the payment of a fixed dividend to claimants or insureds of the insolvent Insurance Company, wherein said dividend is a percentage of allowed claims, the percentage being a function of said values; and
c) receiving at least a portion of the assets of the insolvent Insurance Company, including rights to the insolvent Insurance Company's reinsurers' obligations associated with the liabilities.

2. The method of claim 1 wherein said dividend is calculated by at least adding the value of the insolvent Insurance Company assets, including the expected present value of the reinsurer's obligations, and dividing by the expected present value of associated claims against the Insurance Company.

3. The method of claim 2 further comprising setting aside assets to cover administrative costs of the Insurance Company before calculating said dividend.

4. A method of reinsuring an insolvent Insurance Company's liabilities comprising:
a) estimating a value of the Insurance Company's assets;
b) estimating a value of claims against the Insurance Company;
c) evaluating obligations of reinsurers against said claims;
d) determining the shortfall of the assets including the reinsurers obligations to cover said claims and administrative costs associated with said claims;
e) determining a guaranteed payment rate of said claims as a function of said shortfall;
f) indemnifying at least a portion of the Insurance Company's liabilities for said claims at said guaranteed rate by an Indemnifying Agent; and
g) assigning at least a portion of said assets and Reinsurer's obligations to the Indemnifying Agent.

5. The method of claim 4 further comprising:
assigning to said claims a plurality of priorities and determining a plurality of guaranteed payment rates to correspond to said claims depending on the priority assigned to the claim.

6. The method of claim 4 further comprising:
assigning an upper limit on an aggregate amount the Indemnifying Agent is liable for said claims.

7. The method of claim 4 further comprising:
assigning to said Indemnifying Agent all rights of the Insurance Company for any salvage or subrogation to which the Insurance Company is entitled.

8. The method of claim 4 further comprising:
assigning to the Indemnifying Agent a security interest in at least some of the Insurance Company's rights in secured or special deposits or similar fund held by any state, trusts, letters of credit, and other security due to or held in the Insurance Company's favor.

9. The method of claim 4 further comprising:
appointing a Deputy Liquidator to administer the Insurance Company.

10. A software method for reinsuring an insolvent Insurance company's liabilities using a computer, said method comprising:
a) generating one or more statistical models representative of known cost values based on significant characteristics of historical insurance claims representative of immature insurance claims against the Insurance Company;
b) storing said statistical models in a first memory storage area;
c) determining significant characteristics of said insurance claims for unstated amounts and applying said models to insurance claims for unstated amounts to estimate the actual losses anticipated for those claims;
d) determining the expected amount of the Reinsurer's obligations on the insurance claims for unstated amounts and calculating the present value of the Reinsurer's obligations;
e) calculating a guaranteed payment rate against said claims as a function of the Insurance Company assets, the present value of the Reinsurer's obligations and the present value of underlying claims against the insurance company;
f) storing the guaranteed payment rate in a second memory storage area; and
g) indemnifying the insolvent Insurance Company against the claims at the guaranteed payment rate in exchange for the rights to at least a portion of the Insurance Company's assets including the Reinsurer's obligations.

11. The method of claim 10 further comprising setting aside assets for administrative costs before calculating the guaranteed payment rate.
